(19) United States
(12) Patent Application Publication
(10) Pub. No.: US 2021/0098932 A1
(43) Pub. Date: Apr. 1, 2021

(54) PLUG ASSEMBLY FOR DATA CABLES

(71) Applicant: Neutrik AG, Schaan (LI)

(72) Inventor: Kevin Zechmann, Nenzing (AT)

(21) Appl. No.: 17/045,730

(22) PCT Filed: Apr. 4, 2019
(86) PCT No.: PCT/EP2019/000110

§ 371 Date: Oct. 6, 2020

(30) Foreign Application Priority Data
Apr. 6, 2018 (AT) A50283/2018
Dec. 19, 2018 (AT) A51132/2018

(51) Int. Cl. H01R 13/516; H01R 13/58; H01R 24/64; H01R 13/512; H01R 13/533; H01R 13/639

(52) U.S. Cl. CPC H01R 13/516; H01R 13/5825; H01R 13/639; H01R 13/512; H01R 13/533; H01R 24/64

(57) ABSTRACT

A plug arrangement for use with cables (K) having cable plugs (S) comprises a housing (1) for receiving the cable plug (S), a clamping element (5) encompassing the cable (K) and accommodated in the housing (1), which clamping element (5) clamps, in a compressed state, the cable (K), and a clamping sleeve (3) for establishing a threaded connection with the housing (1). When the threaded connection is tightened, the clamping element (5) is braced in the housing (1) and the cable (K) is clamped in the clamping element (5). The front end of the clamping element (5) facing the cable plug (S) is configured for receiving and positioning the cable plug (S) in a predetermined position at the front end of the clamping element (5) or is provided with at least one stop for the cable plug (S). Thus, when the threaded connection is tightened, the cable plug (S) is also positioned with respect to the housing (1) and the clamping element (5) so as not to rotate and fixed.

The invention relates to a plug arrangement for use with cables having cable plugs, in particular for data cables such as RJ45 cables, optical fibers, electric cables and the like, according to the preamble of claim 1, as well as a plug connection using such a plug arrangement, according to the preamble of claim 14, as well as a clamping element for use in a plug arrangement, according to the preamble of claim 17.

The transmission of electronic data between computing systems via cable is generally know. These cables usually have a plug and/or plug connector, whose configuration is similar to a rectangular telephone plug, having multiple pins. A widely used 8-pin plug is known as “RJ-45” plug among experts. In some applications, the standardized RJ-45 plug is prone to damage and outages. For example, it is not well-suited for repeated plugging and unplugging into and out of particularly a chassis plug socket, the contacts are easily bent or shifted when inserted incorrectly. The plastic latch (spring arm) can fatigue and break so that the plug then no longer fits tightly in the socket. The cable itself is prone to faults due to repeated kinking at the location at which the cable enters the plug socket. Furthermore, the cable can also be pulled out of the plug due to longitudinal strain. The plug housing is formed of plastic and is easily deformed or broken, for example, if being accidentally stepped on. The mentioned disadvantages also apply to other cable connections such as fiber-optic cables, electric cables and many more.

Thus, an arrangement according to EP 1 317 025 B1 has been proposed as a protection for the delicate cable plugs. Moreover, NEUTRIK AG distributes a cable plug protector for pre-assembled cable plugs under the designation NE8MC, consists of housing, stop washer, clamping element, clamping sleeve and anti-kink means. A housing for receiving the actual cable plug has an external thread for establishing, together with a clamping bushing and/or cap nut or clamping nut having an internal thread, for forming a threaded connection. A radially compressible clamping element encompassing the cable is accommodated inside the housing and partially also inside the clamping sleeve, which clamping element, in a compressed state, clamps the cable in the housing. When the threaded connection is tightened, the clamping sleeve, the clamping element, the housing and the cable are braced together, and clamping sleeve, clamping element and housing form a plug arrangement which can be connected to a complementary element such as a plug socket by being plugged together. Depending on the specific embodiment of the cable plug, furthermore, additional adapter pieces fitted to the respective plug must be inserted between the front end of the collet and the cable plug, which increases the installation time and installation effort in a disadvantageous manner. Moreover, suitable adapter pieces must be on hand for each kind of cable plug.

A collet having forwardly protruding fingers for positioning a data plug is also disclosed in CN 204030082 U. In this regard, one of these fingers also serves for holding down the locking tongue of the data plug. The fingers of the embodiment, however, are not configured for accommodating and correctly positioning data plugs of different dimensions, even in the longitudinal direction. Moreover, the collet cannot be used for pre-assembled cables as it has to be pushed onto the cable from the front, only after which the plug can be mounted on the cable. A recess in the housing for accommodating the locking tongue is not provided, either.

The fingers of the collet disclosed in CN 201805068 U also do not allow the safe and correct positioning of data plugs of different dimensions.

The invention has set the object to provide a simply constructed and quick to install device for protecting a cable plug regardless of its kind and for any kind of cables while avoiding the disadvantages of the prior art, by means of which device the risk of damage during plugging into a corresponding plug socket, while it is inserted in the plug socket and during the unplugging out of the plug socket can be avoided or reduced.

This object is achieved by a device according to claims 1 and 14 as well as by using an element according to claim 17. Further features of the invention are to be gathered from the dependent claims, the description and the drawings.

For achieving the object stipulated above, the device according to the invention is characterized in that the front end of the clamping element facing the cable plug is formed for receiving and positioning the cable plug in a predetermined position—both about the longitudinal axis of the plug arrangement and in the longitudinal direction thereof—on the front end of the clamping element or is provided with at least one stop for the cable plug, wherein, when the threaded connection is tightened, the cable plug is positioned so as not to rotate with respect to the housing and the clamping element and fixed, preferably also in the direction of the longitudinal axis at a defined position. This results in a robust, durable plug system for a rough environment, in which system the cable plugs are protected against damage and which offers strain relief for the cable. Preferably, said system is installed on an existing, standardized cable plug which is arranged in a conventional manner on one end of a data cable. Alternative application possibilities are connection plugs of optical fiber cables or also of electric cables, in all cases also for the use with individual contacts instead of cable plugs combining multiple contact elements.

In this regard, a plug arrangement in which at least one constriction of the cross-section is arranged in the direction of the longitudinal axis inside the housing as a stop for the front end of the clamping element. The clamping element supports itself, at least when the threaded connection is tightened, in the direction of the longitudinal axis against the cross-section constriction and is thus exactly positioned in the direction of the longitudinal axis of the housing. This guarantees, in addition to the exact positioning, an optimal connection of the cable plug with its counterpart.

According to a further embodiment according to the invention, the plug arrangement is characterized in that, at least when the threaded connection is tightened, the clamping element is clamped between the cross-section constriction and the clamping sleeve or an element cooperating therewith and is thus exactly positioned in the direction of the longitudinal axis of the housing. This also contributes substantially to establishing an optimal connection of the cable plug with a simultaneous, very good mechanical protection.

In this regard, the clamping element is preferably guided within the housing so as not to rotate about the housing's longitudinal axis, whereby an even quicker and simpler installation can be achieved and combined with an optimal fixation and positioning of the cable plug in the assembled state of the plug arrangement.

In order to ensure, with means as simple and fail-safe as possible, that the clamping element does not rotate in the housing while still achieving an easy longitudinal displaceability, at least one guide for the clamping element, which guide extends in parallel to the direction of the longitudinal axis, is arranged inside the housing according to a further optional feature of the invention. Said guide advantageously cooperates with a complementary structure on the clamping element, if necessary even with the cable plug itself, in particular with its side edges, and thus leads to the desired longitudinal guide without rotation of the clamping element.

In this regard, it is preferably provided that the guide for the clamping element and the complementary structure on the clamping element are formed as a web extending in parallel to the direction of the longitudinal axis of the housing and as a slot extending in parallel to the direction of the longitudinal axis of the housing.

According to an advantageous inventive embodiment, fingers circumferentially distributed about the central longitudinal axis and oriented in parallel thereto are formed on the front end of the clamping element as a receptacle and/or stop for the cable plug and as a stop for the cross-section constriction of the housing, which fingers abut on said cross-section constriction when the threaded connection is tightened. As a result, a simple, quick, exact and yet secure positioning as well as fixation of the cable plug is ensured, which can still be easily inserted into the front end of the clamping element.

In this regard, preferably at least one shoulder is formed laterally in the circumferential direction—with respect to the direction of the longitudinal axis of the plug arrangement—on at least one of the fingers as a receptacle and/or stop for the cable plug. At least when the threaded connection is tightened, the rear end of the cable plug abuts on at least one of the shoulders or, as an alternative to this, is accommodated beween the fingers and thus securely positioned. By means of the location and depth of the shoulder, preferably multiple shoulders arranged in a tiered manner, a different dimensioning of the receiving region for the cable plug can be offered, if necessary in combination with a different rotational position of the clamping element about the cable longitudinal axis. Thus, a clamping element designed in such manner and a plug arrangement containing said clamping element is suited for receiving cable plugs of different dimensions, wherein for all kinds of cable plugs, the exact and safe positioning within the housing of the plug arrangement is guaranteed.

According to an advantageous further embodiment of the plug arrangement according to the invention, a web protruding radially inward is formed on at least one of the fingers. By means of these webs, an increased stability of the clamping element and in particular of the fingers can be achieved.

Moreover, at least one of the fingers is preferably positioned and dimensioned such that a possible spring arm of the cable plug is retained in a position pressed toward the housing of the cable plug by means of said finger. Thus, the spring arm does not obstruct the coupling and latching of the plug connection accomplished solely by the plug arrangement, and also does not have to be removed manually in an additional, complex working step, risking damage to the cable plug.

An embodiment of the clamping element that is easy to produce and robust is characterized in that the clamping element has a cylindrical middle part adjoining the fingers of the front end and a preferably conically tapering rear end opposing the fingers.

In order to ensure the best possible strain relief, the conically tapering rear end of the clamping element preferably has at least two radially compressible fingers whose surfaces facing the cable are configured for an increased positive or frictional connection with the cable.

According to a further optional feature of the invention, a very robust embodiment of the plug arrangement has a housing formed of die-cast metal or plastic. Naturally, the use of other materials is also conceivable.

A further embodiment of the plug arrangement according to the invention is characterized in that, furthermore, a recess is provided in the housing for receiving a possible spring arm of the cable plug and/or a finger of the clamping element, wherein, if applicable, the spring arm is retained in the recess in a pressed position.

A plug arrangement having a clamping element, which has a continuous longitudinal slit parallel to the axis along the length of the clamping element, wherein the clamping element can be elastically pulled apart in the circumferential direction and pushed onto the cable, ensures a quick and safe installation of the plug arrangement on the cable plug having a cable plug using a small number of components.

For achieving the initially stated object, there is also plug connection provided, using a plug connection according to one of the preceding claims.

According to the invention, said plug connection is characterized in that, for forming at least one electric connection, furthermore, a plug socket for correspondingly receiving the plug arrangement is provided. Thus, an optimal protection of the delicate cable plug can be ensured even in a rough environment.

A preferred embodiment according to the invention provides that the housing and the plug socket are provided with complementary structures for longitudinally guiding the housing in the plug socket, in order to ensure the orientation of the plug arrangement with respect to the plug socket upon insertion of the plug arrangement into the socket.

In this regard, the housing is preferably provided with a longitudinal slot and the plug socket is provided with a corresponding counter-longitudinal rib for ensuring the orientation of the plug arrangement with respect to the plug socket upon insertion of the plug arrangement into the socket.

A further optional embodiment of such a plug connection additionally provides a snap latch for the releasable connection of the plug arrangement to the plug socket, in order to safely avoid the inadvertent removal of the cable plug. In the process, the snap latch meshes with an indentation on the outside of the housing.

Finally, a further subject-matter of the invention is a clamping element for use in a plug arrangement for use with cables having cable plugs, wherein said plug arrangement and the clamping element are formed according to one of the paragraphs above. These plug arrangements and clamping elements are used particularly with data cables such as RJ45 cables, but also with optical fibers, electric cables and the like.

For the purpose of better understanding of the invention, it will be elucidated in more detail by means of the figures below.

These show in a respectively very simplified schematic representation:

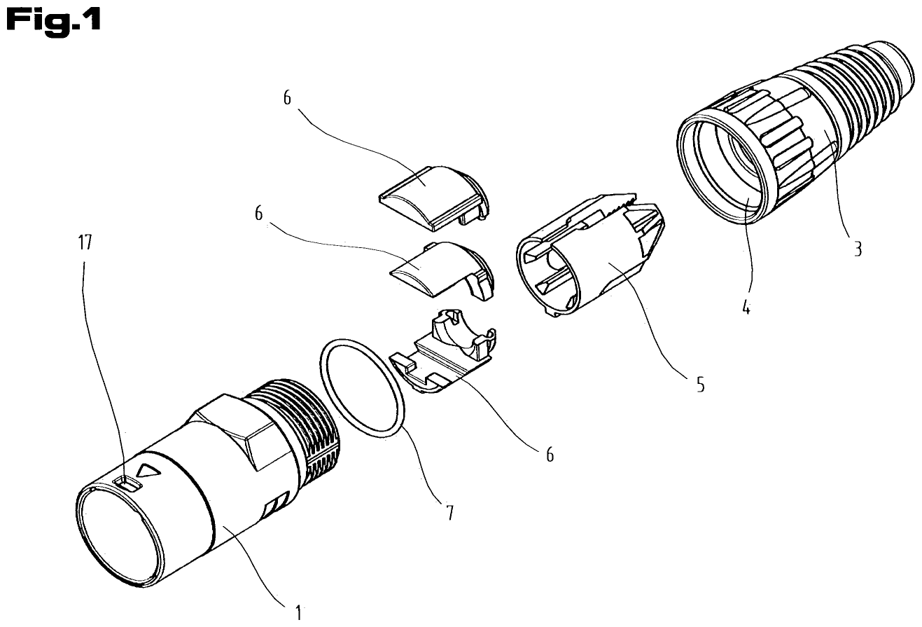

FIG. 1 a plug arrangement according to the prior art in an exploded view;

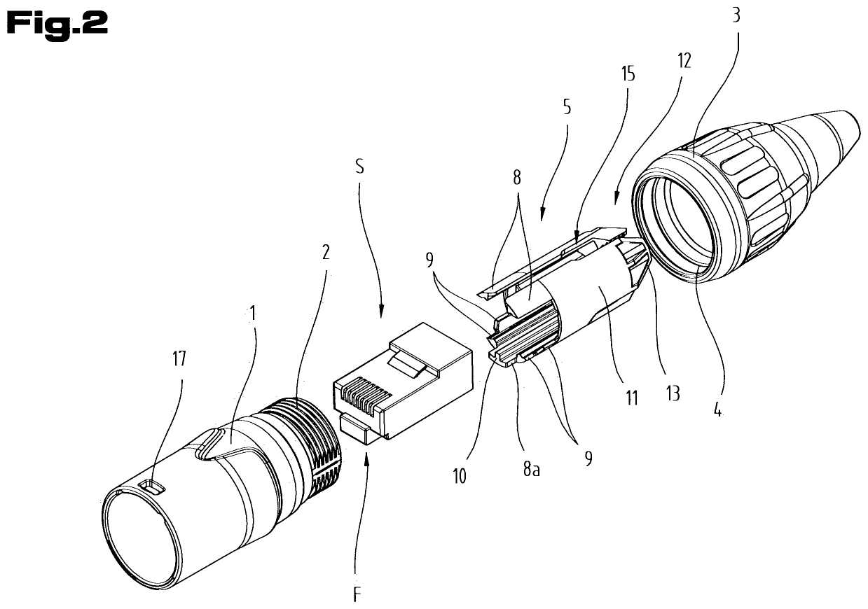

FIG. 2 an exemplary embodiment of a plug arrangement according to the invention, also in an exploded view, with a depiction of the cable plug;

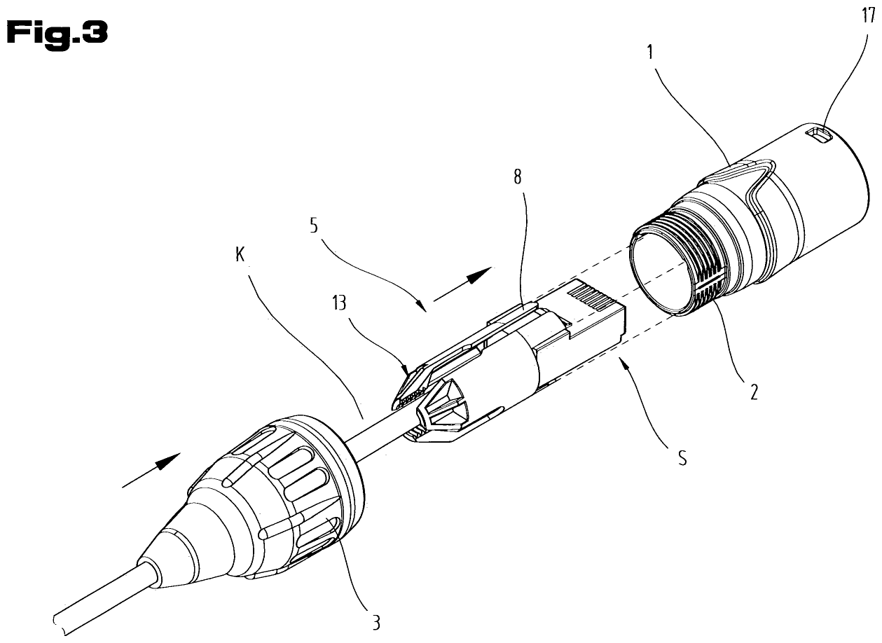

FIG. 3 the plug arrangement of FIG. 2 from a different direction and with the cable plug abutting on the clamping element in the installation position as well as with the cable;

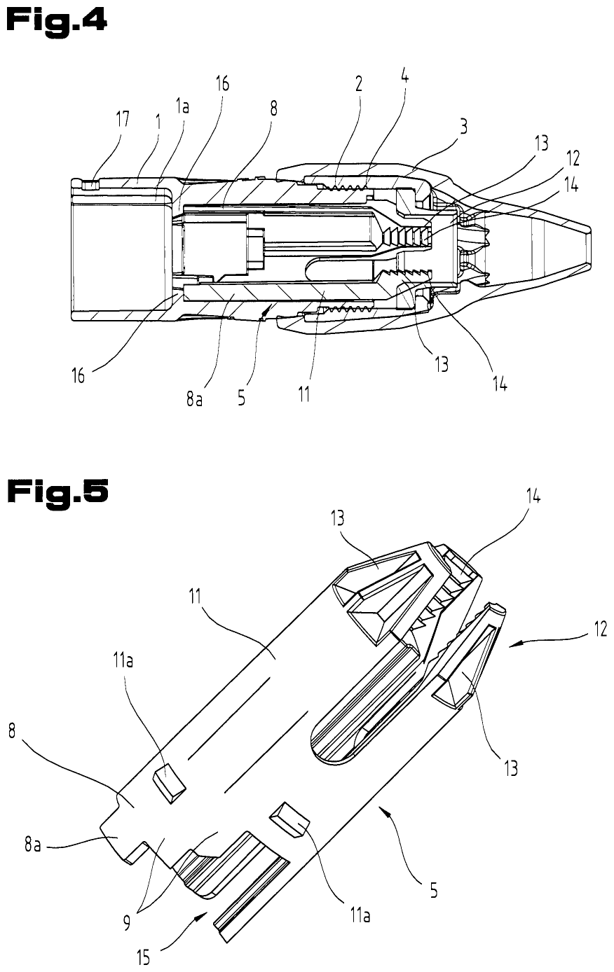

FIG. 4 a longitudinal section along the cable axis through an assembled plug arrangement, without cable and cable plug;

FIG. 5 a clamping element in its embodiment according to the invention in a slightly perspective side view;

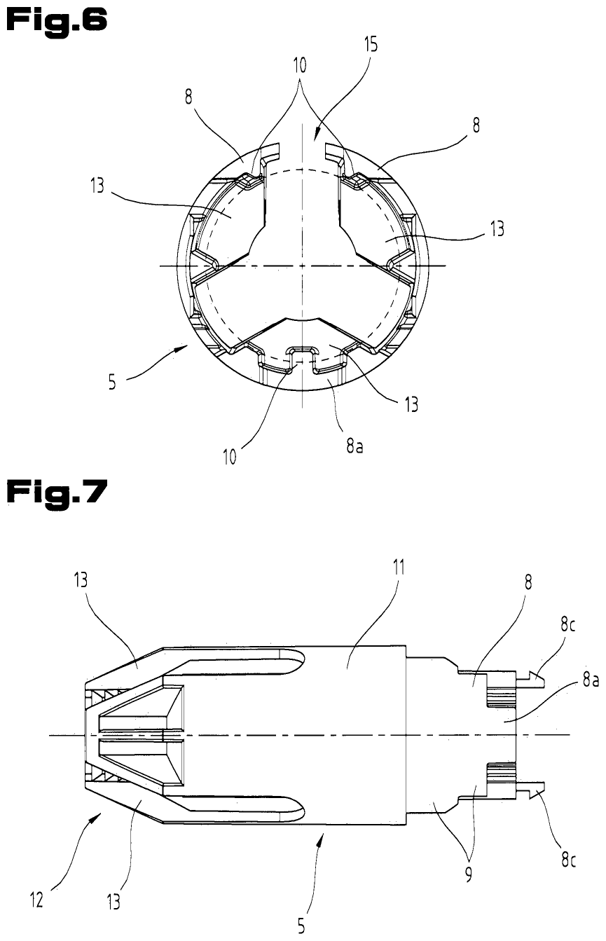

FIG. 6 the clamping element of FIG. 5 in a front view, seen from the direction of the cable plug;

FIG. 7 a side view of the clamping element of FIG. 4;

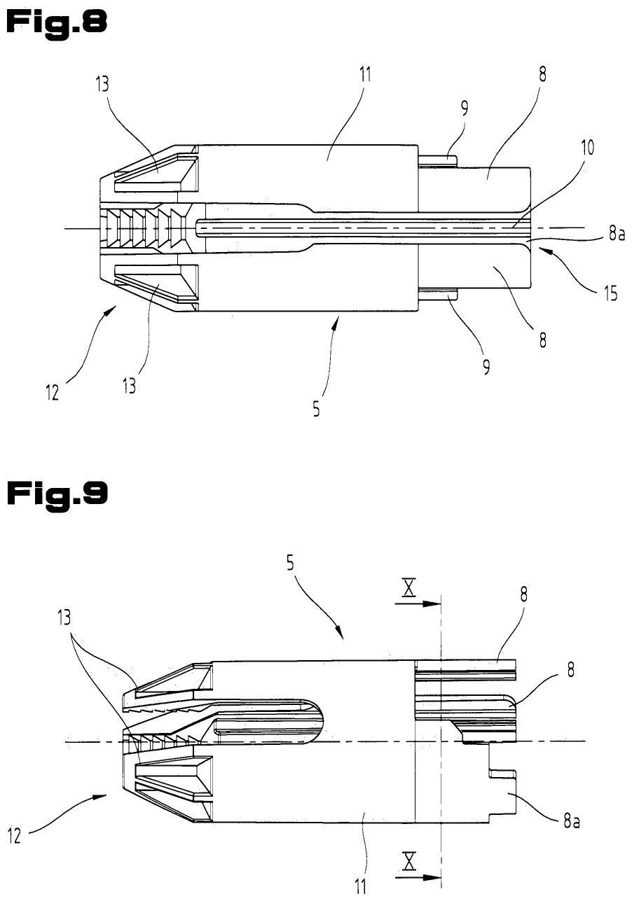

FIG. 8 a side view, rotated by 90 degrees, of the clamping element of FIG. 7;

FIG. 9 a side view, rotated by 45 degrees, of the clamping element of FIG. 7;

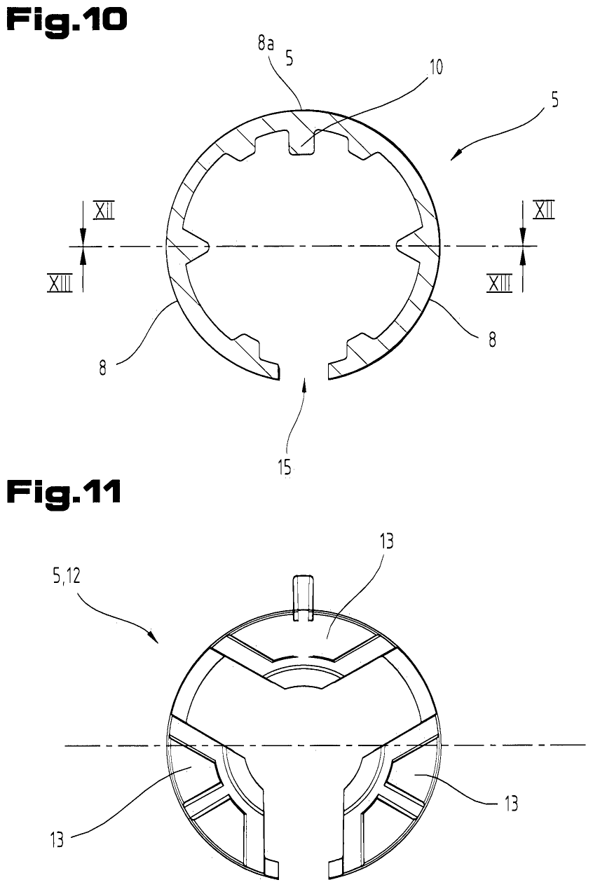

FIG. 10 a section along the line X-X of FIG. 9;

FIG. 11 a view of the clamping element of FIG. 7 onto the rear end;

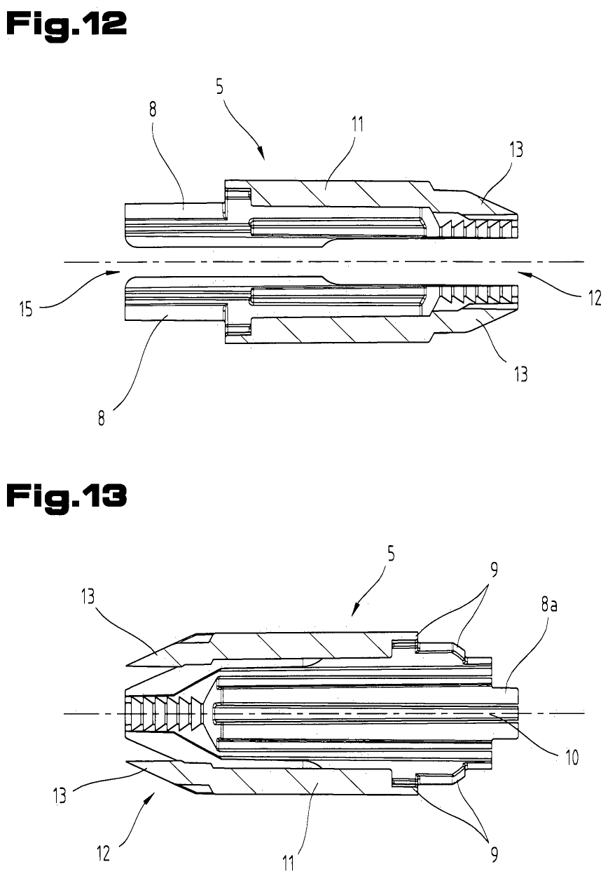

FIG. 12 a longitudinal section through the clamping element of FIG. 7 along the line XII-XII of FIG. 10 in the direction of the small arrows;

FIG. 13 a longitudinal section through the clamping element of FIG. 7 along the line XII-XII of FIG. 10 opposite to the direction of the small arrows;

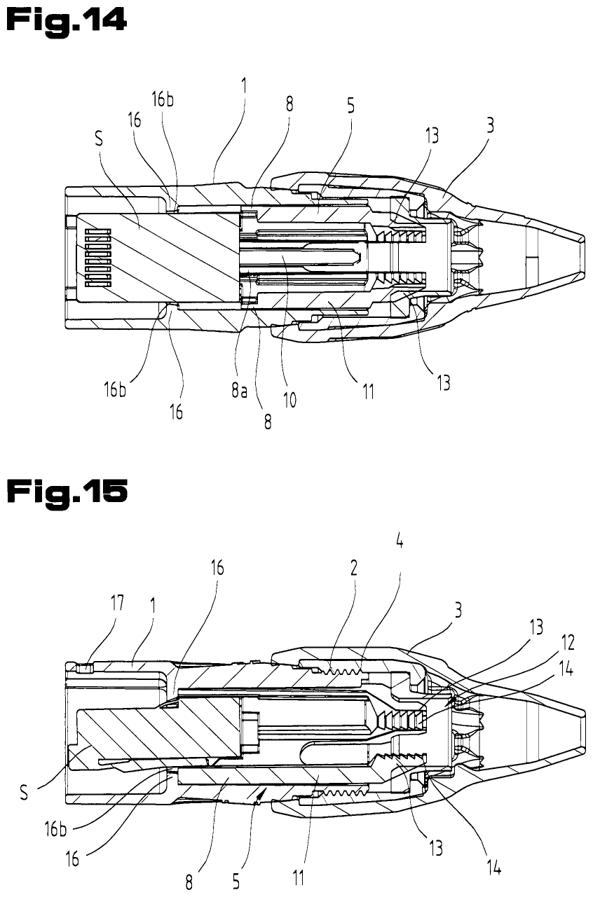

FIG. 14 a longitudinal section, rotated by 90 degrees, through a plug arrangement as shown in FIG. 4, however, with the cable plug inserted;

FIG. 15 a longitudinal section along the cable axis according to FIG. 4, now with the cable plug and inserted, however, without the cable;

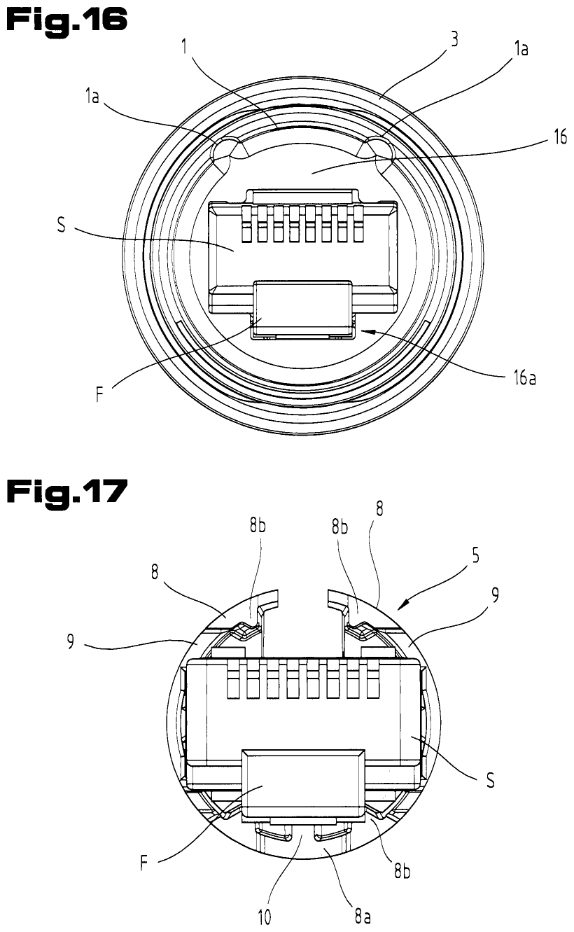

FIG. 16 a front view of the plug arrangement of FIG. 14;

FIG. 17 a front view of the clamping element with the cable plug inserted;

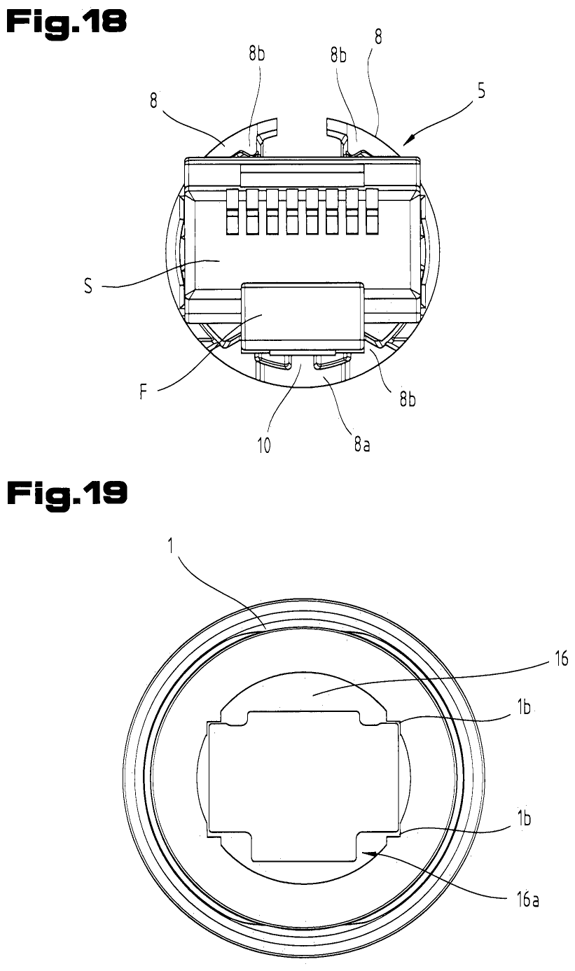

FIG. 18 a front view according to FIG. 17, with cable plugs of different dimensions inserted;

FIG. 19 a view of the housing from the side of the clamping sleeve; and

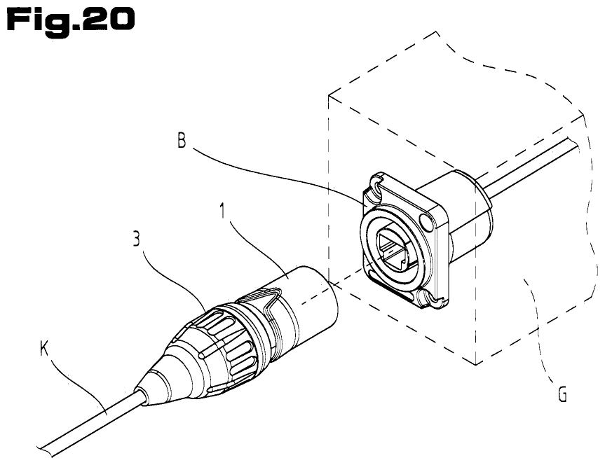

FIG. 20 A representation of a complete system including cable, cable plug according to the invention and complementary plug socket in an appliance.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

The plug arrangement shown in FIG. 1 as cable plug protection particularly for pre-assembled RJ45 plugs consists of a housing 1 configured for plugging into a plug socket, wherein the rear end of said housing 1 is provided with an external thread 2. In the installed state of the plug arrangement, the cable plug is accommodated and fixed inside said housing 1. A clamping sleeve 3 can be screwed onto the housing 1 from behind, meaning from the cable side, thus forming a threaded connection. Additionally, an internal thread 4 is arranged on the front end of the clamping sleeve 3 facing the housing 1. At the latest when this threaded connection is formed, this also compresses a radially compressible clamping element 5 encompassing the data cable and with that clamps the cable in the clamping element 5 and thus also in the plug arrangement. Thus, when the threaded connection is tightened, the clamping sleeve 3, the clamping element 5, the housing 1, and the cable are braced together.

For positioning and fixating the cable plug S in the housing 1, at least two adapter pieces 6 are provided according to the prior art shown in FIG. 1, which adapter pieces 6 must be mounted around the cable plug and inserted, with a rear offset, into the front end of the clamping element 5. The entire arrangement must then, in this configuration in which it is manually held by the user, also be manually inserted into the housing 1. The plug arrangement is supplemented with a washer 7, which is inserted between the housing 1 and clamping sleeve 3 and ensures the dust- and water tightness. This plug arrangement as explained above upgrades a conventional cable plug such as a RJ45 plug to an extremely robust and lockable solution. For different kinds of cable plugs, the adapter pieces 6 are to be selected accordingly.

A further improved solution with fewer components and a simpler assembly is shown in FIGS. 2 to 17. The plug arrangement according to the invention is applicable for all kinds of cable plugs and cables, in particular for data cables and RJ45 cable plugs, but also for optical fibers and their correspondingly configured plug connections, for electric cables and many more. Instead of cable plugs with multiple contact elements, individual contacts can also be used. In the following, the invention is explained with the aid of exemplary embodiments for data cables with RJ45 cable plugs, which, however, is not to be understood in a limiting sense.

As can be seen in FIG. 2, only one clamping element 5 is inserted inside the preferably cylindrical housing 1 open on both sides and the clamping sleeve 3 preferably conically tapered toward the back, which clamping element 5, however, according to the invention, is already configured itself at the front end facing the housing 1 for receiving and positioning a cable plug S having a spring arm F—for purposes of clarity of the representation, the cable is not depicted here—in a predetermined position within the housing 1. The housing 1 is preferably made of die-cast metal, in particular zinc die-casting preferably having one coating, in particular of nickel or chromium. Housings 1 made of plastic are also possible, of course. In this regard, the clamping element 5, preferably made of polyacetal (POM) or also polyamide (PA), is freely rotatable about the central cable axis as long as it is located outside the housing 1 and the threaded connection between the housing 1 and the clamping sleeve 3—in FIG. 4, a section view of a plug arrangement consisting of housing 1, clamping sleeve 3 and clamping element 5 is shown in the longitudinal view—is not yet established. Thus, it can be mounted on the cable during the assembly of the plug arrangement in any position. Only after insertion into the housing 1, the clamping element 5 is then held so as not to rotate by means of guide structures that will be explained below, and therefore the cable plug is also positioned, braced and fixed with respect to the housing 1.

At the front end of the clamping element 5, which is shown in different views and sections in FIGS. 5 to 13, multiple fingers 8 and 8a distributed circumferentially about the central longitudinal axis and oriented in parallel thereto are formed, which fingers 8 and 8a extend from the middle part 11 of the clamping element 5 to the plug-in end of the housing 1. Preferably, three fingers 8, 8a are formed and extend over up to about one third of the total length of the clamping element 5. The cable plug s is inserted—as it is shown in FIG. 3—between the fingers 8, 8a and is then accommodated between the fingers 8, 8a at the latest when the threaded connection of the housing 1 and the clamping sleeve 3 is tightened, and is then safely positioned in a very precisely defined position due to the guidance of the clamping element 5 in the housing 1 and the clamping between the clamping element 5 and inside the housing 1, and is also safely fixed in the plug arrangement by means of the clamping between the housing 1 and the clamping element 5, both with respect to the direction of rotation about the direction of the longitudinal axis and in the longitudinal direction of the plug arrangement.

An embodiment, in which a clamping element 5 is configured for the use with cable plugs S of different outer dimensions, is particularly preferred. This can be achieved, for example, by at least one shoulder 9 and/or offset being formed, in a staggered manner, on at least one of the fingers 8, 8a in the circumferential direction and in the longitudinal direction of the clamping element 5, as a front-side stop surface for the cable plug S of differently dimensioned cable plug S. This can be seen clearly in FIG. 5. In this regard, the cable plug S does not immediately abut on the middle part 11 of the clamping element 5 anymore, but only on the offsets 9 of the fingers 8, 8a.

Preferably, two or also multiple shoulders 9 are provided. The rear side of a cable plug S inserted between the fingers 8, 8a then comes to abut on one of the shoulders 9 depending on the dimensions of the cable plug. This is depicted for two different cable plugs s in the FIGS. 16 and 17 in a front view. Then, as soon as the clamping sleeve 3 is screwed onto the housing 1 and the threaded connection is tightened, the rear end of the cable plug S is accommodated between the fingers 8, 8a, abuts on at least one front face of one of the shoulders 9 and is thus safely positioned and fixed within the housing 1. For the safe and precisely defined positioning of as well as for guiding the cable plug S during the insertion into the clamping element 5, guide ridges 8b having a tooth-shaped cross-section are advantageously formed on the fingers 8, 8a, which guide ridges 8b come into contact with the outside of the cable plug S to guide and hold it.

Furthermore—as it is clearly depicted in FIGS. 2, 6, 10, 13, 16 and 17—a radially inwardly protruding web 10 can be formed on at least one of the fingers 8a, in order to thus significantly increase the stability of said finger 8a and consequently of the entire clamping element 5. This is advantageous particularly when this holding arm 8a is meant and formed for holding a spring tongue F of the cable plug S in the position deformed in the direction of the cable plug housing, so that the spring tongue F neither obstructs the assembly of the plug arrangement nor the establishment and release of the plug connection with the counterpart of the plug arrangement according to the invention. The locking and unlocking of the plug connection is accomplished by other mechanisms on or in the plug arrangement and not by means of the spring tongue F of the cable plug S.

The holding arm 8a for the spring tongue F can be configured in one piece, however, it could be configured to be divided in the direction of the longitudinal axis of the clamping element 5, wherein the division region only extends across the length of the receiving region of a cable plug S. The or any web 10 can also be used for guiding the cable plug S in the direction of the longitudinal axis upon insertion of the same into the clamping element 5, as well as contribute to the safe positioning of the cable plug S in the circumferential direction of the plug arrangement by forming a stop for one of the longitudinal edges of the cable plug S, which plug prevents a—further—rotation of said cable plug S within and relative to the clamping element 5.

Similar to the known embodiment of the clamping element 5, this one has a cylindrical middle part 11 adjoining the fingers 8, 8a of the front end and a preferably conically tapering rear end 12 opposing the fingers 8, 8a.

Said rear end 12, in turn, has at least two radially compressible fingers 13, whose surfaces facing the cable K are configured for an increased positive or frictional connection with the cable K. These surfaces can, for example, have a sawtooth-like profile, so that the tips of the saw teeth push into the plastic encasement of the cable upon compression of the fingers 13 in the course of the tightening of the threaded connection between housing 1 and clamping sleeve 3, and thus effect the clamping between cable K and clamping element 5. This way, tensile stresses of the cable K are separated from the cable plug S and instead are transferred via the clamping element 5 on to the housing 1, and absorbed by the latter and/or by the plug connection between housing 1 and the corresponding plug socket.

The clamping element 5 is preferably designed in one piece and has, for an easy and quick mounting onto the cable, a continuous longitudinal slit 15 along the length of the clamping element 5. This offers the possibility to pull apart the clamping element 5 in the circumferential direction, after which it can then be easily pushed onto the cable K. A longitudinal web protruding from the internal wall of the plug housing 1, extending in parallel to the longitudinal axis of the same engages with the slot formed between the two longitudinal sides of the slit 15 of the clamping element 5. The longitudinal slot of the clamping sleeve and the longitudinal web cooperate and form a guide and/or a rotation prevention and effect the exact alignment of the clamping sleeve in the circumferential direction of the plug housing.

However, the clamping element 5 can also be designed to be completely closed in the circumferential direction and is then pushed onto the cable K in its longitudinal direction before mounting the cable plug S. In this case, appropriate structures are to be formed on the clamping element 5 and in the housing 1 for the rotation preventing guide, for example, a longitudinal slot that does not penetrate the entire material thickness of the clamping element 5 or protrusions in and/or on the clamping element 5 arranged to be aligning in the direction of the longitudinal axis for receiving a longitudinal rib in the housing 1 or for engaging with a longitudinal slot in the housing 1, so that a rotation prevention of the clamping element 5 in the housing 1 is ensured.

When assembling the plug arrangement according to the invention, first, the clamping sleeve 3 is pushed over the end of the cable with the cable plug. Subsequently, the clamping element 5 can be applied to the cable, wherein the cable is guided through the longitudinal slit 15 toward the longitudinal central axis of the clamping element 5. Then, the clamping element 5 is pushed forward toward the cable plug, which consequently arrives at a lying position between the fingers 8 and is supported by their shoulders 9. The entire arrangement of cable, cable plug and clamping element 5 is then inserted into the housing 1.

Preferably, a cross-section constriction in the form of a broken-through dividing wall 16 is arranged in the housing 1, which dividing wall 16 forms a stop for the front end of the finger 8. At least the two fingers 8 immediately adjoining the longitudinal edge of the longitudinal slit 15 of the clamping element 5 form, with their front sides, the stops for the longitudinal positioning of the clamping element 5 in the housing 1. The front end of the cable plug S protrudes, as is shown in FIG. 14 in the longitudinal section, through the opening in the dividing wall 16, which front end protrudes forward beyond the front sides of the fingers 8, 8a of the clamping element 5. The opening is formed according to the cross-section profile of the cable plug S and, if necessary, provided with a recess for receiving the front region of the spring arm F of the cable plug S. Its rear region is preferably held in a depressed position by the finger 8a. The recess in the dividing wall 16 is preferably dimensioned, such that the front end of the finger 8a is also accommodated and the dividing wall 16 can grip through to safely hold the spring arm F in a depressed position. In this case, the front side of the first shoulder 9 of the finger 8a is intended as the stop on the dividing wall 16. If necessary, the dividing wall 16 could also have a recess extending in the direction of the longitudinal axis for receiving the finger 8a.

If necessary, the function of forcing the spring arm F down can also be effected by a correspondingly dimensioned recess in the dividing wall 16. The dividing wall 16 is arranged inside the housing 1 on a longitudinal point, which is selected for obtaining the desired positioning of the cable plug S in the housing 1 and with respect to the plug socket for ensuring an optimal plug connection. For this case, an embodiment of the clamping element 5 is provided, in which no long finger 8a protruding beyond the spring arm F is present but all fingers 8 have the substantially same length.

In the housing 1 of the plug arrangement according to the invention, longitudinal guide slots 1b or longitudinal guide bars can also be formed on the side of the dividing wall 16 facing the clamping sleeve 3, which guide slots 1b or guide bars extend in an aligning manner to the corner regions of the aperture in the dividing wall 16 and serve for correctly guiding the cable plug S in the circumferential direction upon insertion into the housing 1. Longitudinal slots la on the side of the dividing wall 16 facing the counterpart of the housing 1 in the plug socket mainly serve for indexation, in order to avoid confusion with different, similarly built plug types. Optionally, they can also serve as guides for the circumferentially correct combining for establishing the plug connection.

For completing the plug arrangement according to the invention, the clamping sleeve 3 is screwed onto the housing 1, so that the threaded connection between the external thread 2 of the housing 1 and the internal thread 4 of the clamping sleeve 3 is established. On the one hand, the rear fingers 13 of the clamping element 5 are thereby pressed onto the cable K and thus, the clamping element 5 is clamped onto the cable K. Simultaneously, the clamping element 5 in with its fingers 8 and possibly also 8a is thereby moved up against the dividing wall 16 and/or clamped between the clamping sleeve 3 and dividing wall 16, so that all components are braced against one another and the cable plug S is positioned and fixed in the housing 1 in a safe and protected manner. In this regard, by clamping the clamping element 5 and receiving the cable plug S in or on its front side, a very exact positioning in the direction of the longitudinal axis as well as in the circumferential direction of the plug arrangement is ensured. On the other hand, the elasticity of the material of the clamping element 5 and a low slackness, meaning a small intermediate space 16a, between the internal wall of the recess in the dividing wall 16 and the cable plug S offer the possibility that the cable plug S can be pivoted by a small angle at least in the direction of at least one of the two main axes of the recess in the dividing wall 16. Thus, small tolerances and differences in orientation of the plug arrangement and its counterpart can be compensated, whereby the plugging together of the two complementary assembly groups for establishing the connection between two cable ends and/or one cable end and one appliance is substantially simplified.

On the front sides of the fingers 8, 8a, latch projections 8c—please refer to FIG. 7 on this—for fixating the clamping element 5 inside the housing 1 can be formed where appropriate, in order to fixate the clamping element 5 in the housing 1 and to protect it against pulling out or sliding out. Latch projections 11a which engage with complementary structures in or on the inside of the housing 1 could, if necessary, also be positioned on the circumferential surface of the clamping element 5, in the region of the fingers 8, 8a or of the middle part 11, as is shown by way of example in FIG. 5.

Using a plug arrangement as it is described above, a particularly robust plug connection can be realized by a plug socket B being provided for the correspondingly receiving the plug arrangement 1, 3, 5. The housing 1 can, if necessary, be provided with a longitudinal slot, and the plug socket B, which is built into an appliance G (please refer to FIG. 20 on this), for example as a built-in plug connector, can be provided with a corresponding counter-longitudinal rib, in order to ensure the orientation of the plug arrangement with respect to the plug socket B upon insertion of the plug arrangement into the plug socket. In order to avoid the inadvertent removal of the cable plug, additionally, a snap latch and/or spring latch can be provided as an optional further feature for the releasable connection of the plug arrangement with the plug socket. This snap latch then preferably meshes with an indentation 17 on the outside of the housing 1.

The exemplary embodiments and the preceding description as well as the enclosed drawings disclose possible embodiment variants, wherein, however, the invention is not limited to the specifically represented embodiment variants. In fact, various combinations of the individual embodiment variants are possible, and due to the teaching of the present invention, and this possibility of variation owing to the teaching provided by the present invention lies within the ability of the person skilled in the art in this technical field.

### LIST OF REFERENCE NUMBERS

1 housing
1a longitudinal slot
1b guide slot
2 external thread
3 clamping sleeve
4 internal thread
5 clamping element
6 adapter piece
7 washer
8 front finger
8a spring arm finger
8b web
8c latch projection
9 shoulder
10 web
11 middle part
11a latch projection
12 conical rear end
13 rear finger
14 sawtooth structure
15 longitudinal slot
16 dividing wall
16a recess
16b intermediate space
17 indentation
K cable
S cable plug
F spring arm
B socket
G appliance

1. A plug arrangement for use with cables (K) having cable plugs (S), in particular data cables such as RJ45 cables, optical fibers, electric cables and the like, comprising:
a) a housing (1) for receiving the cable plug (S), with a thread (2) arranged on one of its faces;
b) a clamping element (5) which is radially compressible and encompasses the cable (K) and is accommodated in the housing (1), which clamping element (5), in a compressed state, clamps the cable (K);
c) a clamping sleeve (3) having a thread (4) for forming a threaded connection with the thread (2) on the housing (1);
wherein, when the threaded connection is tightened, the clamping sleeve (3), the clamping element (5), the housing (1) and the cable (K) are braced together,
characterized in that
the front end of the clamping element (5) facing the cable plug (S) is formed for receiving and positioning the cable plug (S) in a predetermined position on the front end of the clamping element (5) or is provided with at least one stop for the cable plug (S),
wherein, when the threaded connection is tightened, the cable plug (S) is positioned and fixed so as not to rotate with respect to the housing (1) and the clamping element (5) and/or in the direction of the longitudinal axis.

2. The plug arrangement according to claim 1, characterized in that at least one cross-section constriction (16) is arranged inside the housing (1) in the direction of the longitudinal axis as a stop for the front end of the clamping element (5), wherein the clamping element (5) supports itself, at least when the threaded connection is tightened, in the direction of the longitudinal axis on the cross-section constriction (16) and is thus exactly positioned in the direction of the longitudinal axis of the housing (1).

3. The plug arrangement according to claim 2, characterized in that, at least when the threaded connection is tightened, the clamping element (5) is clamped between the cross-section constriction (16) and the clamping sleeve (3) or an element cooperating therewith and is thus exactly positioned in the direction of the longitudinal axis of the housing (1).

4. The plug arrangement according to one of claims 1 to 3, characterized in that the clamping element (5) is guided inside the housing (1) about its longitudinal axis so as not to rotate.

5. The plug arrangement according to claim 4, characterized in that at least one guide for the clamping element (5), which guide extends in parallel to the direction of the longitudinal axis, is arranged inside the housing (1), wherein said guide cooperates with a complementary structure on the clamping element (5) or with the cable plug (S) itself.

6. The plug arrangement according to claim 5, characterized in that the guide for the clamping element (5) and the complementary structure on the clamping element are formed as a web extending in parallel to the direction of the longitudinal axis of the housing (1) and as a slot extending in parallel to the direction of the longitudinal axis of the housing (1).

7. The plug arrangement according to one of claims 1 to 6, characterized in that multiple fingers (8, 8a) circumferentially distributed about the central longitudinal axis and oriented in parallel thereto are formed on the front end of the clamping element (5) as a receptacle and/or stop for the cable plug (S) and as a stop for the cross-section constriction (16) of the housing (1), which fingers (8, 8a) abut on said cross-section constriction when the threaded connection is tightened.

8. The plug arrangement according to claim 7, characterized in that at least one shoulder (9) is formed laterally when seen in the circumferential direction, on at least one of the fingers (8, 8a) as a receptacle and/or stop for the cable plug (S).

9. The plug arrangement according to claim 7 or 8, characterized in that, on at least one of the fingers (8, 8a), a web (8b, 10) protruding radially inwardly is formed.

10. The plug arrangement according to one of claims 7 to 9, characterized in that at least one of the fingers (8a) is preferably positioned and dimensioned such that a possible spring arm (F) of the cable plug (S) is retained in a position pressed toward the housing of the cable plug (S) by means of said finger (8a).

11. The plug arrangement according to one of claims 1 to 10, characterized in that the clamping element (5) has a cylindrical middle part (11) adjoining the fingers (8, 8a) and a preferably conically tapering rear end (12) opposing the fingers (8, 8a), wherein the conically tapering rear end (12) of the clamping element (5) has at least two radially compressible fingers (13), whose surfaces (14) facing the cable (K) are configured for an increased positive or frictional connection with the cable (K).

12. The plug arrangement according to one of claims 1 to 11, characterized in that a recess (16a) is provided in the housing (1) for receiving a possible spring arm (F) of the cable plug (S) and/or a finger (8a) of the clamping element (5), wherein, if applicable, the spring arm (F) is retained in the recess in a pressed position.

13. The plug arrangement according to one of claims 1 to 12, characterized in that the clamping element (5) has a continuous longitudinal slit (15) parallel to the axis along the length of the clamping element (5), wherein the clamping element (5) can be elastically pulled apart in its circumferential direction and pushed onto the cable (K).

14. A plug connection using a plug arrangement according to one of claims 1 to 13, characterized in that, for establishing at least one electric connection, furthermore, a plug socket is provided to correspondingly receive a plug arrangement according to one of claims 1 to 13.

15. The plug connection according to claim 14, characterized in that the housing (1) and the plug socket are provided with complementary structures for longitudinally guiding the housing (1) in the plug socket, in order to ensure the orientation of the plug arrangement with respect to the plug socket upon insertion of the plug arrangement into the socket, wherein the housing (1) is preferably provided with a longitudinal slot and the plug socket is provided with a corresponding counter-longitudinal rib.

16. The plug connection according to claim 14 or 15, characterized in that, additionally, a snap latch for the releasable connection of the plug arrangement with the plug socket is provided, wherein the snap latch engages with an indentation (17) on the outside of the housing (1).

17. A clamping element (5) for use in a plug arrangement for use with cables (K) having cable plugs (S), in particular for data cables such as RJ45 cables, optical fibers, electric cables and the like, according to one of claims 1 to 13, characterized in that the clamping element (5) is embodied according to one of claims 7 to 11.
